(19) United States
(12) Patent Application Publication
(10) Pub. No.: US 2014/0281556 A1
(43) Pub. Date: Sep. 18, 2014

(54) MEDIA PRESENTATION DESCRIPTION VERIFICATION

(71) Applicant: QUALCOMM INCORPORATED, San Diego, CA (US)

(72) Inventors: Yinian MAO, San Diego, CA (US); Fatih ULUPINAR, San Diego, CA (US)

(73) Assignee: QUALCOMM INCORPORATED, San Diego, CA (US)

(21) Appl. No.: 13/802,721

(22) Filed: Mar. 14, 2013

(51) Int. Cl. H04L 9/32

(52) U.S. Cl. CPC H04L 9/3247
USPC 713/176

(57) ABSTRACT

Methods and systems are described for verifying the source and integrity of a media presentation description (MPD) defined by the Dynamic Adaptive Streaming over HTTP (DASH) protocol. A streaming client receives an MPD from an MPD publisher. The MPD can include addresses associated with one or more media servers and/or advertising servers. The streaming client can receive from the MPD publisher at least one of a digital signature, cryptographic key, and certificate information associated with the MPD. The streaming client can verify the legitimacy of the MPD by verifying the digital signature using the received cryptographic key. The streaming client may use the certificate information to verify the MPD. The streaming client can prevent playing the media associated with the MPD if the MPD is not legitimate. The legitimacy of servers associated with addresses in the MPD may also be verified using authentication information for servers stored in the MPD.

### BACKGROUND

Dynamic Adaptive Streaming over HTTP (DASH) is a media delivery protocol that stores media as segments downloadable by DASH-compliant clients via HTTP. The DASH protocol defines a Media Presentation Description (MPD) that contains information about media segments, such as the temporal location of the segment within a stream, information about the server where the segment can be accessed, a resolution of the segment, etc.

To play a media stream or file, the DASH-compliant client can request an MPD and subsequently obtain media segments indicated in the MPD. When the media is advertising supported, the MPD may contain information that the client can use to obtain advertising segments. If a user wishes to avoid advertising content associated with media content, the user's client may obtain an MPD that is modified to remove or alter information pertaining to obtaining advertising content. For example, the MPD may be modified such that an address associated with an advertising server where advertising segments can be obtained is replaced with an address associated with a server that is not a legitimate advertising server. The client can use the modified MPD to obtain short duration media-segments in lieu of the advertising segments originally indicated by the MPD. MPDs that are modified to avoid the advertising associated with media threaten the advertising-supported business model of content providers utilizing the DASH protocol

Additionally, efforts to avoid advertising associated with media content may involve changing information in a domain name system (DNS) name server to cause a request directed to a legitimate server to be redirected to an illegitimate server.

### SUMMARY

Methods and systems are described for verifying at a streaming client that a Media Presentation Description (MPD) for requested media has not been modified.

In one embodiment, a method is described in which a streaming client may receive a media presentation description (MPD). The MPD may include at least one address associated with a server. The streaming client may receive a digital signature associated with the MPD. The digital signature may be based on a first cryptographic key. The streaming client may verify whether the MPD is legitimate using a second cryptographic key. The streaming client may prevent playing the media content associated with the MPD if the MPD is not legitimate. The streaming client may play the media associated with the MPD if the MPD is legitimate.

In another embodiment, a method is described in which a streaming client may receive an MPD. The MPD may include at least one address associated with a server. The streaming client may receive a digital signature associated with the MPD. The digital signature may be based on a first cryptographic key. The streaming client may verify whether the MPD is legitimate using a second cryptographic key. The streaming client may play the media associated with the MPD if the MPD is legitimate.

In a further embodiment, a method is described in which an MPD publisher may send an MPD to a streaming client. The MPD may include at least one address associated with a server. A digital signature associated with the MPD may be sent to the streaming client. The digital signature may be based on a first cryptographic key. The MPD publisher also sends a cryptographic key to the streaming client. The streaming client may be configured to use a second cryptographic key to verify whether the MPD is legitimate.

In additional embodiments, non-transitory computer readable media for storing program code executable by a processor may be provided to perform one or more of these and/or other methods. In additional embodiments, a computer system may be provided. The computer system may include a memory and a processor coupled to the memory. The processor may be configured with processor-executable instructions to perform one or more of these and/or other methods.

### BRIEF DESCRIPTION OF THE DRAWINGS

FIG. 1 shows an illustrative system diagram for a block streaming system in which MPD verification may occur.

FIG. 2 illustrates possible structures of segments of a media presentation description (“MPD”) file.

FIG. 3 illustrates an exemplary use of DASH for adaptive bitrate streaming by a streaming client.

FIG. 4 shows an illustrative sequence diagram indicating communications between an ad server, a media server, an MPD publisher and a streaming client according to an embodiment.

FIG. 5 is an illustrative flow diagram for verifying the legitimacy of an MPD, according to an embodiment.

FIG. 6 is an illustrative flow diagram for verifying the legitimacy of a server associated with an address indicated an MPD segment.

FIG. 7 is an illustrative block diagram of a computer system.

### DETAILED DESCRIPTION

To play media content, a client that uses the Dynamic Adaptive Streaming over HTTP (DASH) protocol may obtain a media presentation description (MPD) from a media publisher. The MPD can include information that the streaming client can use to fetch media content segments and advertising segments from a media server.

To allow a streaming client to verify that an MPD is legitimate, the MPD publisher may publish the MPD with a digital signature and/or certificate information. The streaming client may verify the certificate information and digital signature to determine that the MPD has been authored by a legitimate source and has not been modified in the communication path to the streaming client.

An MPD can contain authentication information for an advertising server that the streaming client can use to authenticate the advertising server. If the authentication is unsuccessful, the streaming client may prevent subsequent playback of advertising content from the advertising server. In some embodiments, the streaming client may also prevent subsequent playback of media content associated with the MPD when authentication is unsuccessful.

FIG. 1 shows an illustrative system diagram for a block streaming system 100 in which MPD verification may occur. Block streaming system 100 may include block serving infrastructure 102. Block serving infrastructure 102 may include ingestion system 104, ingested content store 106, and media server 108. Media content 110 may be stored in a database or other data storage system. Ingestion system 104 may ingest media content 110, prepare and package the media content 110, and store the content at ingested content store 106. Ingested content store 106 may be a database or other data storage system. Media server 108 may be an HTTP streaming server or other server configured to receive and respond to requests for media content. An MPD publisher 112 may publish MPDs and generate digital signatures for MPDs. A streaming client 114, such as an HTTP streaming client, may obtain an MPD from MPD publisher 112 and send requests for media content to media server 108. In some embodiments, a cache such as an HTTP cache may provide content to streaming client 114 in response to requests for media content sent to media server 108.

Streaming client 114 may be a device or software executable on a device. The device or software may be configured to provide media playback capabilities. For example, streaming client 114 may be a personal computer; a mobile device such as a cellular phone, media player, tablet, laptop computer; or other device capable of playing streaming media.

Streaming client 114 may obtain advertising content from ad server 116. Advertising content may be stored in ad content database 118. Ad content database 118 may be stored on ad server 108 or may be stored on one or more servers communicatively coupled to ad server 108. Advertising content may be shown before, after, concurrently with, or interspersed within media content. The terms “advertising” and “ad” are used interchangeably herein. Typically, media content is content that is requested by a user, for example, by using a user interface of streaming client 114. Advertising content 118 may be unrequested content that is provided to streaming client 114 in association with the requested media content.

Media content 110 and ad content 118 may include such as audio, movies, 2D planar video, 3D video, other types of video, images, timed data presentations, hybrid presentations, images, timed text, timed metadata, and the like, referred to herein as “presentations.” Some content might involve data that is to be presented or consumed in a timed manner, such as data for presenting auxiliary information (station identification, advertising, stock quotes, Adobe Flash media player sequences, etc.) along with other media being played out. Other hybrid presentations might also be used that combine other media and/or go beyond merely audio and video. Presentations may include previously recorded files or broadcast content.

Each element shown in FIG. 1 might be implemented, at least in part, in software, therein comprising program code that is executed on one or more processors or other electronic components. For example, one or more of media ingestion system 104, ingested content store 106, media server 108, media content store 110, MPD publisher 112, streaming client 114, and ad server 116 may be located on the same device. Elements shown in FIG. 1 can communicate via wired and/or wireless connections and via networks such as a wide area network (WAN), local area network (LAN), the Internet, a cellular network, other network, or a combination thereof.

FIG. 2 illustrates possible structures of segments in media presentation description (“MPD”) 200. As described herein, an MPD comprises information regarding the representations of a media presentation. Various representation of the media presentation may be available to the client. Details of possible implementations of MPD structures or files will now be described. In many examples, the MPD is described as a file, but non-file structures can be used as well.

Media ingestion system 104 can receive a presentation from media content store 110 and generate encoded media segments from the presentation. A media segment may be a subsection of video and/or audio from a presentation. Multiple collections of segments may represent the same time period within a presentation. Generating multiple segments representing the same time period can allow selection at streaming client 114 of options such as various resolutions, camera angles, languages, etc. The encoded media segments may be stored at content store 106.

MPD 200 may include period records 202, e.g., records 202(1)-(3). A period may be an interval of time in a presentation. Typically, the periods of a presentation are consecutive and non-overlapping. A period record 202 may include representation records 204, e.g., 204(1)-204(2). Representations 204 may be alternatives in a sense that the client selects one out the different alternatives, or they may be complementary in a sense that the client selects several of the representations, each possibly also from a set of alternatives, and presents them jointly. The representations may advantageously be assigned to adaptation sets, with the client programmed or configured to understand that, for representations in one adaptation set, they are each alternatives to each other, whereas representations from different adaptation sets are such that more than one representation is to be presented jointly. In other words, if there is more than one representation in an adaptation set, the client may pick one representation from that adaptation set, one representation from the next adaptation set, etc., to form a presentation.

MPD 200 may include signals to obtain advertising content before, during, and/or after a presentation of media content. For example, some period records 202 of MPD 200 may be periods for media content and other period records 202 may be periods for advertising content.

Information describing representations may advantageously include details of the applied media codecs including profiles and levels of those codecs that are required to decode the representation, video frame rates, video resolution and data rates. Streaming client 114 may use this information when receiving media to determine in advance whether a representation 204 is suitable for decoding or presentation.

Streaming client 114 may switch between representations from one period to the next. For example, when streaming client 114 is obtaining data from media server 108 via a network, the network bandwidth available to streaming client 114 may vary over time. Streaming client 114 may use an adaptive bitrate streaming technique by selecting a representation with a relatively low bitrate (e.g., 100 kbits/second) when available bandwidth is low, and, if available bandwidth subsequently increases, selecting a representation with a relatively high bitrate (e.g., 500 kbits/second) for a subsequent period.

A representation record 204 may contain a sequence of segments 206 e.g., 206(1)-206(2). The representation may contain segment information 208 such as references to initialization segments 210 and media segments 206. A segment 206 may indicate information about the segment such as an address associated with a server at which the segment is located. The address may be a uniform resource locator (URL). Streaming client 114 can download a segment 206 using the URL indicated for the segment. MPD 200 may include some segments 206 that include a URL associated with a media server 108 and other segments 206 that include a URL associated with an advertising server 116.

MPD 200 may include information restricting the client requests based on the time of day. For example, for a live service the client may be restricted to requesting parts of the presentation that are close to the “current broadcast time”. This may be advantageous for live broadcast, as it may be desirable to purge data from the serving infrastructure for content that was broadcast more than a provided threshold before the current broadcast time.

In a further embodiment of the invention, segments 206 may be compliant with the ISO Base Media File Format described in ISO/IEC 14496-12 or derived specifications (such as the 3GP file format described in 3GPP Technical Specification 26.244).

The representations in a media presentation can be synchronized in a global timeline to ensure seamless switching across representations, typically being alternatives, and to ensure synchronous presentation of two or more representations. Sample timing of contained media in representations within an adaptive HTTP streaming media presentation can be related to a continuous global timeline across multiple segments.

A block of encoded media content or advertising content containing media of multiple types, for example audio and video, may have different presentation end times for the different types of media. In a block request streaming system, such media blocks may be played out consecutively by streaming client 114 in such a way that each media type is played continuously and thus media samples of one type from one block may be played out before media samples of another type of the preceding block. As an alternative, media blocks may be played out such that the earliest sample of any type of one block is played after the latest sample of any type of the preceding block.

MPD 200 may contain metadata that streaming client 114 can use to construct appropriate file requests, for example HTTP GET requests, to access the data at appropriate time and to provide the streaming service to the user. MPD 200 may provide sufficient information for streaming client 114 to select the appropriate files and pieces of files.

The information in a media presentation description is advantageously used by streaming client 114 to perform requests for files/segments or parts thereof at appropriate times, selecting the segments from adequate representations that match its capabilities, for example in terms of access bandwidth, display capabilities, codec capabilities, and so on as well as preferences of the user such as language, and so on. Furthermore, as MPD 200 describes representations that are time-aligned and mapped to a global timeline, the client may also use the information in the MPD during an ongoing media presentation for initiating appropriate actions to switch across representations, to present representations jointly or to seek within the media presentation.

FIG. 3 illustrates an exemplary use of DASH for adaptive bitrate streaming by streaming client 114. Various segments 206 are available at different bitrates (250 kbit/second, 500 kbit/second, and 1 Mbit/second) for media content 110 and advertising content 118. Streaming client 114 may select segments 206 encoded for use at different bitrates as network throughput quality changes, as indicated by line 302. For example, streaming client 114 may download a first segment encoded for use at 250 kbit/second, as indicated by 302. When throughput quality subsequently improves, streaming client 114 may download a second segment encoded for use at 500 kbit/second, as indicated by 302. Streaming client 114 may download a third segment encoded for use at 1 Mbit/second, as indicated by 302. MPD 200 may signal that ad content 118 is to be obtained. If the throughput quality is 1 Mbit/second, streaming client 114 may obtain a fourth segment 206 with ad content 118 encoded for a bitrate of 1 Mbit/second. After the ad content 118 has been obtained, streaming client 114 may resume obtaining media content 110.

FIG. 4 shows an illustrative sequence diagram 400 indicating communications between an ad server 116, a media server 108, an MPD publisher 112 and a streaming client 114 according to an embodiment. Typically, a user will use a user interface of streaming client 114 to request playback of a particular media file. At 402, streaming client 114 may send a request to MPD publisher 112 for an MPD 200 associated with media content, such as the requested media file. MPD publisher 112 can respond by sending MPD 200 to streaming client 114, as indicated at 404. Prior to sending MPD 200, such as at the time MPD 200 is published, MPD publisher 112 may digitally sign the MPD with a digital signature using a cryptographic key, such as a private key of a public-private key pair or a shared secret key. For example, to create a digital signature for an MPD, a cryptographic key may be applied to a hash of data of the MPD. MPD publisher 112 may send the digitally signed MPD 200 to streaming client 114. A digital signature is a scheme for demonstrating the authenticity of a document such as an MPD.

An MPD publisher cryptographic key, such as a public key of a public-private key pair, may also be transmitted to streaming client 114. The public key may be a “subject public key” as indicated in the Internet X.509 Public Key Infrastructure standard of the Network Working Group (RFC 2459). The MPD publisher cryptographic key may be sent to streaming client 114 from MPD publisher 112 or from another source, such as an entity that performs key distribution for MPD publisher 112. Streaming client 114 can receive the MPD publisher cryptographic key prior to receiving the MPD, at the same time as receiving the MPD, or after receiving the MPD. The MPD publisher cryptographic key sent to streaming client 114 may be a shared secret key or a public key of a public-private key pair.

After streaming client 114 has received the MPD 200, streaming client 114 may use the digital signature to determine the integrity of MPD 200 and whether MPD 200 has been received from a legitimate source. Streaming client 114 may use the MPD publisher cryptographic key to verify the digital signature of the MPD 200.

MPD publisher 112 may additionally send certificate information to streaming client 114. After streaming client 114 has received the MPD 200, streaming client 114 may use the certificate information to determine if the MPD 200 has been received from a legitimate source.

If streaming client 114 determines that MPD 200 is not legitimate, streaming client 114 can prevent media content associated with the MPD from being obtained. If streaming client 114 determines that MPD 200 is legitimate, streaming client 114 can request media content from media server 108, as indicated at 406. For example, streaming client 114 can request a segment 206 of media content from media server 108 based on segment information 208 contained in MPD 200. Media server 108 can provide the requested media content, as indicated at 408. Media server may continue receiving and responding to requests for segments 210 of media content, e.g., until an advertising period occurs, until all periods 202 of MPD 200 have been received, or until streaming client 114 halts playback.

When MPD 200 includes ad content segments 206, streaming client 114 may obtain ad content 118 from ad server 116, as indicated at 412. Ad server 116 can deliver ad content to streaming client 114, as indicated at 414. It will be understood that a request for ad content 412 may occur prior to a request for media content 406. Advertising may occur prior to, during, and/or after playback of media content, according to information indicated by MPD 200.

Streaming client 114 may continue to obtain media content after playback of advertising content as indicated at 416-418.

FIG. 5 is an illustrative flow diagram for verifying the legitimacy of an MPD 200, according to an embodiment. At operation 502, MPD publisher 112 can digitally sign MPD 200 using a cryptographic key such as a private key associated with the MPD publisher. Operation 502 may occur at the time that MPD 200 is published. At operation 504, streaming client 114 receives MPD 200 from MPD publisher 112. Streaming client 114 may also receive a digital signature generated by MPD publisher 112 and an MPD publisher cryptographic key usable by streaming client 114 to decrypt the digital signature.

Streaming client 114 may also receive certificate information, such as a certificate chain including a certificate authority (CA) certificate and a certificate issued by a CA to the MPD publisher. Streaming client 114 may receive some or all of the certificate information from MPD publisher 112. Certificate information received by streaming client 114 may include a certificate authority public key usable to verify the certificate of the certificate authority. For example, streaming client 114 may receive a CA key, such as a root public key associated with the certificate. Streaming client 114 can receive the CA key prior to receiving the MPD, at the same time as receiving the MPD, or after receiving the MPD. In some embodiments, streaming client 114 is provisioned with a CA key. For example, when software for streaming client 114 is installed or otherwise initially stored to a processor, the software may include the CA key. Alternatively, the CA key may be sent to streaming client 114 from MPD publisher 112 or from another source. Certificate information may further include an MPD publisher cryptographic key. For example, a public key of MPD publisher 112 usable to verify the MPD digital signature may be included in the certificate issued by a CA to the MPD publisher.

A certificate authority (CA) is an entity, such as a commercial entity or organization, that issues digital certificates. The certificate authority may issue a digital certificate vouching for the identity of the subject of the certificate when it has verified the identity of the subject. The digital certificate certifies to recipients of the certificate that the ownership of a public key is by the named subject of the certificate.

At operations 506-508, streaming client 114 may verify the legitimacy of MPD 200. Verifying the legitimacy of MPD 200 may include verifying a digital signature associated with the MPD, and, when the MPD has an associated certificate, verifying a certificate associated with the MPD.

When streaming client 114 has received an MPD having associated certificate information, streaming client 114 may verify the certificate information, as indicated at operation 506. Verifying the certificate information may involve one or more of: determining whether the current time (e.g. as indicated by the system clock of streaming client 114) falls within a validity period associated with the certificate; verifying a subject name in the certificate; verifying a revocation status of the certificate; verifying extensions present in the certificate; and verifying the certificate signature using a CA key. If the certificate is verified, streaming client 114 may determine whether the certificate is signed by a trusted certificate authority (e.g., as indicated in a database stored by or accessible to streaming client 114). A certificate may be part of a chain of certificates. When a certificate is not trusted, streaming client 114 may verify the next certificate in the chain and determine if the next certificate is trusted. If a certificate fails verification or if no trusted certificate is located, the streaming client 114 determines that MPD 200 is not a legitimate MPD. In some embodiments, streaming client 114 is provisioned with a root of trust certificate that identifies a trusted root certificate authority.

To verify the integrity of MPD 200, streaming client 114 can use the MPD publisher cryptographic key (e.g., a public key of MPD publisher 112) to verify a digital signature associated with MPD 200, as indicated at 508.

At decision diamond 510, it is determined whether MPD 200 is legitimate. If the integrity of MPD 200 is successfully verified, streaming client 114 may begin to request media segments 206 indicated by MPD 200, as indicated at 512. If MPD 200 is not verified, streaming client 114 may not request the media segments indicated by MPD 200, as indicated at 514. In this manner, if an MPD has been modified to remove or alter directions to download advertising content, streaming client 114 will not play media associated with the MPD.

Streaming client 114 may receive an MPD 200, such as an updated MPD, including an address that has been altered. For example, when streaming client 114 is receiving live streaming content, streaming client 114 may receive periodic updates to the MPD. Each updated MPD may be verified as indicated in FIG. 5.

In some embodiments, streaming client 114 may perform a server verification to avoid vulnerability to rerouting attacks. For example, an attack may occur in which data introduced into the cache database of a domain name system (DNS) name server causes a request directed to a legitimate server to be redirected to an illegitimate server. For example, a request directed to a legitimate ad server 116 may be re-routed to an illegitimate server. To prevent downloading of content from a server that is not a legitimate server, streaming client 114 may verify the legitimacy of a server using a certificate associated with the server. A link to the certificate may be included in the MPD, for example, as a URL in segment 206. Accordingly, in some embodiments, segment 206 may include a first URL indicating an address associated with a certificate for an ad server and a second URL indicating an address at which ad content can be downloaded. This approach may additionally be used to verify servers that are not ad servers, such as media server 108.

FIG. 6 is an illustrative flow diagram for verifying the legitimacy of a server associated with an address indicated an MPD segment 206. At operation 602, MPD publisher 112 can digitally sign MPD 200 using an MPD publisher cryptographic key. At operation 604, streaming client 114 receives MPD 200 from MPD publisher 112. Streaming client 114 may also receive the digital signature generated by MPD publisher 112. Typically, streaming client 114 will have received an MPD publisher cryptographic key usable by streaming client 114 to decrypt the digital signature prior to receiving MPD 200. Alternatively, streaming client 114 may further receive a certificate chain from MPD publisher 112 and use the certificate chain to verify the MPD signature.

At decision diamond 606, streaming client 114 may verify the legitimacy of MPD 200 as described with reference to operations 506-508 of FIG. 5. If the integrity of MPD 200 is successfully verified, streaming client 114 may begin to request media segments 206 indicated by MPD 200, as indicated at 610. If MPD 200 is not verified, streaming client 114 may not request the media segments indicated by MPD 200, as indicated at 612. In some embodiments, MPD verification as indicated at 602-612 may be bypassed.

At operation 614, a server associated with a URL indicated by MPD 200 may be verified. The server may be ad server 118. For example, if MPD 200 includes information for advertising segments, the ad server associated with the URL for the advertising segments can be verified. In this manner, if an address in a segment leads to an illegitimate server (e.g., a URL has been remapped to a different server), streaming client 114 can prevent playback of segments from a server associated with the remapped URL. In some embodiments, MPD 200 may include a link to one or more items of certificate information for a server, such as a certificate chain including a certificate authority (CA) certificate and a certificate issued by a CA to the server. For example, a segment 206 may include an address associated with a server and one or more items of certificate information associated with the server. The certificate information may be verified as indicated with reference to operation 506 of FIG. 5. Streaming client 114 may additionally receive a shared secret key for authenticating ad server 118. The shared secret key may be received by streaming client 114 from MPD publisher 112 via a secure communication channel. Streaming client 114 may use the shared secret key to verify the legitimacy of the ad server, for example, through a challenge-response procedure.

At decision diamond 616, it is determined whether ad server 118 is legitimate. If ad server 118 is legitimate, client 114 may obtain segments 206 from the ad server, as indicated at 618. If the ad server verification is not successful, client 114 may bypass segments indicating URLs associated with ad server 118, as indicated at 620. In some embodiments, if the ad server verification is not successful, client will not issue any subsequent requests for segments associated with the MPD.

While 614-620 indicate determining whether an ad server is legitimate, it will be recognized that any server associated with a URL indicated in MPD 200 could be verified using this approach.

When an MPD 200 is initially transmitted by media publisher 112 to streaming client 114, it may be desirable to transmit the MPD via a secure communication channel, i.e. a channel that is confidentiality and integrity protected. Similarly, when the MPD is updated, it may be desirable to transmit the updated MPD via a secure channel. Streaming client 114 may establish a secure session with MPD publisher 112 to receive the updated MPD. Such a session may be established using HTTP secure (HTTPS). HTTPS layers the hypertext transfer protocol (HTTP) on top of a protocol such as the Transport Layer Security (TLS) or Secure Sockets Layer (SSL). TLS and SSL are cryptographic protocols based on public key cryptography. A client may authenticate a server using the TLS and/or SSL protocol.

In some embodiments, prior to verification of an MPD by streaming client 114, the streaming client itself may be authenticated. Streaming client authentication may be performed using a TLS session. As streaming client 114 establishes a session with media server 108 and/or MPD publisher 112, streaming client may authenticate one or more of 108 and/or MPD publisher 112. One or more of media server 108 and/or MPD publisher 112 may authenticate streaming client 114. The authentication can be performed based on the public key infrastructure (PKI). Streaming client 114 may store authentication information such as certificate information usable to verify media server 108 and/or MPD publisher 112 as well as certificate information associated with streaming client 114 and a private key of streaming client 114. Media server 108 and/or MPD publisher 112 may also store a private key. The client certificate information may contain a unique client ID that may allow media server 108 and/or MPD publisher 112 to maintain a record of streaming client 114.

A mutual authentication between streaming client 114 and media server 108 and/or MPD publisher 112 can be based on a challenge-response procedure. For example, the TLS protocol can be used. The TLS protocol may be as described in RFC 5246. Streaming client 114 may exchange certificate information with media server 108 and/or MPD publisher 112. The certificate information may be verified by both streaming client 114 and by media server 108 and/or MPD publisher 112. Streaming client 114 and media server 108 and/or MPD publisher 112 may send out random numbers as challenges. To prove the identity, the recipient of the challenge must be able to sign the received challenge using its private key. The signatures are exchanged between the challengers to allow verification of the signature. In some embodiments, after the mutual authentication is successfully performed, a session key can be established using a scheme such as Diffie Hellman to allow subsequent media streaming to be authenticated.

FIG. 7 is an illustrative block diagram of a computer system that may be used to implement any of the entities or components described above (e.g., media content store 110, media ingestion system 104, ingested content store 106, media server 108, media publisher 112, streaming client 114, and ad server 116). The computer system may be implemented as a combination of hardware and software components, according to various embodiments. The computer system may comprise a set of instructions that can be executed to cause the system to perform any one or more of the methodologies discussed herein. The computer system may be realized as a specific machine in the form of a computer. The system may be a server computer; a personal computer (PC); a mobile device such as a cellular phone, media player, tablet, laptop computer; or any system capable of executing a set of instructions (sequential or otherwise) that specify actions to be taken by that system. Further, while only a single system is illustrated, the term “system” shall also be taken to include any collection of systems that individually or jointly execute a set (or multiple sets) of instructions to perform any one or more of the methodologies discussed herein.

The computer system may include the processor 702 (e.g., a central processing unit (CPU)), a memory 704 which may store program code during execution, and non-volatile storage 706, all of which communicate with each other via a bus 700. The system may further include a video display unit 708 (e.g., a liquid crystal display (LCD) or cathode ray tube (CRT)). The system also may include an alphanumeric input device 710 (e.g., a keyboard), and a network interface device 712 for receiving content source and delivering content store.

The non-volatile storage unit 706 may include a machine-readable medium on which may be stored one or more sets of instructions (e.g., software) embodying any one or more of the methodologies or functions described herein. The instructions may also reside, completely or at least partially, within the memory 704 and/or within the processor 702 during execution thereof by the system, with the memory 704 and the ingestion processor 702 constituting machine-readable media.

Further embodiments can be envisioned to one of ordinary skill in the art after reading this disclosure. In other embodiments, combinations or sub-combinations of the above disclosed invention can be advantageously made. The example arrangements of components are shown for purposes of illustration and it should be understood that combinations, additions, re-arrangements, and the like are contemplated in alternative embodiments of the present invention. Thus, while the invention has been described with respect to exemplary embodiments, one skilled in the art will recognize that numerous modifications are possible.

For example, the processes described herein may be implemented using hardware components, software components, and/or any combination thereof. In some cases, the software components can be provided on tangible, non-transitory media for execution on hardware that is provided with the media or is separate from the media. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

What is claimed is:

1. A computer-implemented method, comprising:
receiving, by a streaming client, a media presentation description (MPD) from an MPD publisher, wherein the MPD includes at least one address associated with a server;
receiving, by the streaming client, a digital signature associated with the MPD, wherein the digital signature is based on a first cryptographic key; and
verifying, by the streaming client, whether the MPD is legitimate, wherein a second cryptographic key is used for the verifying.

2. The method of claim 1, wherein the streaming client prevents playing the media content associated with the MPD if the MPD is not legitimate.

3. The method of claim 1, wherein the media content associated with the MPD is played by the streaming client if the MPD is legitimate.

4. The method of claim 1, wherein the address is associated with an advertising server or a media server.

5. The method of claim 1, wherein the streaming client uses a Dynamic Adaptive Streaming over HTTP (DASH) protocol.

6. The method of claim 1, further comprising using certificate information received by the streaming client to verify whether the MPD is legitimate.

7. The method of claim 1, wherein the first cryptographic key is the private key of a public-private key pair and wherein second cryptographic key is a public key of a public-private key pair.

8. The method of claim 1, wherein the first cryptographic key is a shared secret key and the second cryptographic key is the shared secret key.

9. The method of claim 1, wherein the MPD is received using one of a secure sockets layer (SSL) protocol or a transport layer security (protocol).

10. The method of claim 1, wherein the MPD is received by the client using Hypertext Transfer Protocol Secure (HTTPS).

11. The method of claim 1, wherein the MPD includes authentication information associated with the server; and
verifying, using the authentication information, whether the server is legitimate; and
if the server is legitimate, requesting media content from the server.

12. The method of claim 11, wherein the authentication information is associated with an advertising server or a media server.

13. The method of claim 11, wherein the authentication information is certificate information associated with the server.

14. The method of claim 11, wherein the authentication information is a shared secret key.

15. Non-transitory computer readable media for storing program code executable by a processor of a streaming client, the program code including instructions for performing the method of any of one of claim 1 to claim 14.

16. A computer system comprising:
a memory; and
a processor coupled to the memory, the processor configured with processor-executable instructions to perform the method of any one of claim 1 to claim 14.

17. A computer system comprising:
a streaming client including:
means for receiving a media presentation description (MPD) from an MPD publisher, wherein the MPD includes at least one address associated with a server;
means for receiving a digital signature associated with the MPD, wherein the digital signature is based on a first cryptographic key; and
means for verifying whether the MPD is legitimate, wherein a second cryptographic key is used for the verifying.

18. The computer system of claim 17, wherein the streaming client uses a Dynamic Adaptive Streaming over HTTP (DASH) protocol.

19. A computer-implemented method, comprising:
receiving, by a streaming client, a media presentation description (MPD) from an MPD publisher, wherein the MPD includes at least one address associated with a server;
receiving, by the streaming client, certificate information associated with the MPD publisher; and
verifying, using the certificate information, whether the MPD is legitimate.

20. The method of claim 19, wherein the MPD includes authentication information associated with the server; and
verifying, using the authentication information, whether the server is legitimate, and;
if the server is legitimate, requesting media content from the server.

21. The method of claim 19, wherein the streaming client prevents playing the media content associated with the MPD if the MPD is not legitimate.

22. The method of claim 19, wherein the media content associated with the MPD is played by the streaming client if the MPD is legitimate.

23. Non-transitory computer readable media for storing program code executable by a processor of a streaming client, the program code including instructions for performing the method of any one of claim 19 to claim 22.

24. A computer system comprising:
a memory; and
a processor coupled to the memory, the processor configured with processor-executable instructions to perform the method of any one of claim 19 to claim 22.

25. A computer-implemented method, comprising:
sending, from an MPD publisher, a media presentation description (MPD) to a streaming client, wherein the MPD includes at least one address associated with a server; and
sending, to the streaming client, a digital signature associated with the MPD, wherein the digital signature is based on a first cryptographic key;
wherein the streaming client is configured to use a second cryptographic key to verify whether the MPD is legitimate.

26. The method of claim 25, further comprising using a certificate chain associated with the streaming client whether the streaming client is legitimate.

27. Non-transitory computer readable media for storing program code executable by a processor of a server, the program code including instructions for performing the method of any one of claim 25 to claim 26.

28. A computer system comprising:
a memory; and
a processor coupled to the memory, the processor configured with processor-executable instructions to perform the method of any one of claim 25 to claim 26.
